(19) United States
(12) Patent Application Publication
(10) Pub. No.: US 2005/0170060 A1
(43) Pub. Date: Aug. 4, 2005

(54) Process for producing a low fat, concentrated meat broth from meat by-products

(76) Inventors: Sree Raghavan, South Brunswick, NJ (US); James LaMarta, Boonton, NJ (US); Pradip Shah, Edison, NJ (US); Joanna Holmes, Englishtown, NJ (US); Sambasiva Chigurupati, Omaha, NE (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/769,186

(22) Filed: Jan. 30, 2004

(51) Int. Cl. A23L 1/238

(52) U.S. Cl. 426/589

(57) ABSTRACT

A process for developing a low fat, concentrated meat broth from animal products and by-products. A commercial broth product is the result of the fat and water removal process. The broth is used as a key base ingredient for development of a variety of flavorings.

### FIELD OF INVENTION

The present invention relates to a novel, solvent-free process for developing a low fat, concentrated broth from animal by-products and, more particularly, to a membrane filtration process for removing fat and retaining and concentrating non-fat solids from chicken products and by-products including chicken skins and mechanically separated chicken. Additionally, the invention relates to products of the filtration process and broths made from the product of the filtration process.

### BACKGROUND OF INVENTION

Typically, low-fat commercial chicken broths contain up to 32% solids and around 1% fat. The standard of identity also calls for a moisture-to-protein ratio of 135:1 that equates to a minimum presence of approximately 0.7% proteinaceous matter in the broth. Given the high fat content and relatively low total non-fat solids of chicken by-products, it is currently not economically feasible to make a low-fat, liquid chicken broth having at least 32% solids from chicken by-products such as chicken skins. As such, chicken by-products are often considered to be waste material. Preparing commercial chicken broth from chicken skins, which naturally contain large amounts of fat, has not been widely attempted due, in part, to the time and expense involved in removing sufficient fat and extraneous matter from the skins and the difficulty in yielding a low-fat chicken broth having 32% solids or higher with a favorable flavor and flavor precursor content. Reducing the fat content to less than 1% while increasing the total non-fat solids content to 32% or higher is a difficult task. The value of this broth and other meat broths is, to a large extent, based on the amount of non-fat solids contained in the broths. Producing such a broth from by-products currently considered to be waste material would increase the value of the by-products to the meat industry, increase profits currently realized from by-products, and lessen the amount of waste material in the meat industry.

It is common practice in the industry for meat broths to be prepared from low cost animal products and by-products such as mechanically separated meats, skins, hides, and other non-muscle tissues; however, use of such products creates a number of processing issues. (The terms “products” and “By-products” are used interchangeably throughout the specification and claims.) Most animal products and by-products contain large amounts of fat and other extraneous matter as part of their composition. For chicken meat with skin, the fat content is typically around 15% by weight. Raw chicken skins, however, have a fat content that can range from 30 to 55% of their total composition.

Some animal parts contain such large amounts of fat, it is not economical to use these parts in order to make meat broths due to the time and expense involved in removing the fat. High levels of fat in a broth impart a strong fatty aroma that deviates from the desired flavor profile for a broth. Such a broth appears less “brothy” and more “fatty/oily” in character. Of further concern is the low amount of non-fat solids, primarily proteinaceous matter, available in these sources. In order to produce a viable broth, the product must contain a certain quantity of non-fat solids. It is the level of these solids that determine the price and value of the broth. Finally, many animal by-products have characteristic off-odors that, like fat, interfere with the production of a base broth that could serve as a primary ingredient in the production of flavors such as chicken or beef flavor.

Added fat is also problematic because ingesting large amounts of animal fat is not healthy and can lead to health problems. Most consumers have learned to check the ingredient listing on food products to determine the percentage of total fat and/or saturated fat in a product. Consequently, the market demand for meat broths is based on little or no fat present in the broth. The ability to remove large amounts of fat from an animal product could mean the difference between disposing of the product and using the product in the manufacturing process. In general, meat products made primarily from muscle tissues are relatively expensive and not extensively used for the preparation of meat broths. To use animal by-products for the development of broths, the fat and/or the intense undesirable aromas associated with the kind of by-product used must first be reduced or eliminated.

Many processes are available for removal of fat from fatty meat by-products. Centrifuges have been traditionally used in the food industry to separate and remove lipids from animal products. (The terms “fat” and “lipid” and “non-fat” and “non-lipid” are used interchangeably throughout the specification and claims.) While centrifugation can be used to remove and recover fat from chicken by-products, this process does not consistently remove all of the fat or other impurities in a chicken skin broth matrix. It is believed that the failure of centrifuges to completely remove all fat from this broth is due in part to interferences from extensive foaming observed when chicken skin broth is subject to centrifugal forces. The recovery of solids, particularly the soluble solids, from chicken broth is also a major challenge. While it may be possible for a stand-alone centrifugation process to generate a 32% solids or higher broth, centrifuge-based fat separation techniques are usually coupled to other dehydration techniques to achieve the necessary concentration effect. However, with every increase in the concentration factor, a concurrent increase in the residual lipid content is also observed. As a result, a broth developed through centrifugation and dehydration of a high fat source material such as chicken skins has an unacceptable fat content and accompanying flavor and flavor precursor profiles.

A solvent extraction process can also lower fat effectively. However, the process is not a popular technique in the food industry due to stringent regulations against the presence of toxic residual solvent in foods. Other fat removal techniques include salt precipitation, high pressure extraction, supercritical fluid extraction and the use of coalescers. These techniques all have some limitations such as high cost, high energy consumption, long preparation times, artifact generation and thermal abuse. More importantly, the inability to reach a target residual fat content of less than 1% is a major limitation of many of these operations.

In the food industry, solids concentration is traditionally done through thermal dehydration techniques such as evaporation and spray drying. The exposure of meat solids, and in particular the flavor yielding proteinaceous matter, to high evaporative and spray drying temperatures for extended time periods can result in significant loss of these valuable flavor precursors through thermal and/or atmospheric degradation and reactions. Thermal abuse can also result in artifact formation which can lead to flavor distortion and loss. The end result is a drop in the solids content and the accompanying loss of flavor precursors that are important ingredients for the development of flavorings from the meat broth. Other concentration techniques not involving high heat such as freeze-drying and fluid bed dehydration are relatively cost prohibitive.

Currently, the food industry does not use an exclusive filtration system to obtain chicken broth from chicken skins in part due to the difficulty in achieving a concentrated broth of 32% solids or higher. The large amount of particulate material in these chicken by-products compounded by the physical size of the by-products appear to clog the filters and render the membranes impenetrable.

Until now, it was not believed possible to obtain low fat broth containing at least 32% solids and having an acceptable flavor and or flavor precursor content using a filtration system. Usually, chicken skins are rendered to recover the oil, which is sold as chicken fat. The solids from these skins, which contain significant amounts of fat are usually discarded or used as animal feed. Due to the high fat content and the low percentage of solids in the final product, chicken skin solids are often considered to be disposable by-products when the demand for chicken fat drops.

What is desired is a method for using chicken skins to form a broth by removing the fat from the chicken skins, recovering and concentrating the non-fat solids, and retaining an acceptable flavor and flavor precursor content so that the resulting commercial broth is low in fat, contains at least 32% solids, and is appropriate for use as a base in developing chicken flavors. This process should be more economical and efficient than currently known processes and should not rely on chemical treatments, such as the use of solvents, or abusive heat treatments for fat removal and solids concentration.

### SUMMARY OF INVENTION

The present invention relates to a membrane filtration process for developing low fat, high solids meat broths from animal products, such as chicken skins, mechanically separated chicken, and the resultant product. The membrane filtration process is a solvent-free, non-thermally abusive, fat removal and solids concentration technique. The process includes the following steps: at least one enzyme hydrolysis step, at least one microfiltration step and at least one reverse osmosis filtration step. With this membrane filtration process, a low-fat broth having at least 32% solids is obtained. The end result of the removal of fat from chicken products, such as chicken skins and mechanically separated chicken is the generation of a low-fat broth product, which can be used as a base to develop various chicken and other poultry flavorings for use in food products.

In particular, the membrane filtration process can be used to process chicken skins from a low value raw material to a commercially valuable chicken broth. The resulting chicken broth is low in fat (less than 1%) and has a solids content of at least 32%. Through the removal of virtually all of the fat from the resulting broth, much of the fatty off-flavor aromas associated with raw and cooked chicken skins are also eliminated. The result is the creation of a chicken broth from an inexpensive raw material that is low in fat, high in non-fat solids, low in off-odors and contains the broth-like flavor associated with such a product. The broth is well suited as a base ingredient for development of chicken flavors and as substitute for commercial chicken broths currently sold in the marketplace.

The present invention discloses a process which removes fat from animal by-products without degrading the properties of the resultant meat broth. Off-flavor constituents and fat are removed from the broth while significant amounts of proteinaceous solids are retained. The stability and retention of the meat flavors and flavor precursors are enhanced in the process due to the use of temperatures below 110° F. (43° C.) during the membrane filtration process. A further advantage of the present invention is that it does not rely on the use of chemical treatments, such as solvents, to remove the fat. Thus, the broth produced by the process contains a significant amount of proteinaceous solids, flavors and flavor precursors desirable in a meat broth.

### BRIEF DESCRIPTION OF DRAWINGS

Attention is now directed to the drawings where like numerals and characters indicate like or corresponding components. In the drawings

FIG. 1 is a table indicating the results of fat reduction using microfiltration vs. centrifugation;

FIG. 2 is a diagram of the steps in the process of the present invention indicating which material is retained and which material is further filtered in the reverse osmosis step to yield the low-fat, high solids, flavorful chicken broth; and

FIG. 3 is a table comparing the pre- and post filtered chicken broth;

FIG. 4 is a graph comparing the changes in the fat and non-fat composition of chicken skins during microfiltration; and,

FIG. 5 is a graph indicating changes in the “off-flavor” profile of the chicken broth during microfiltration.

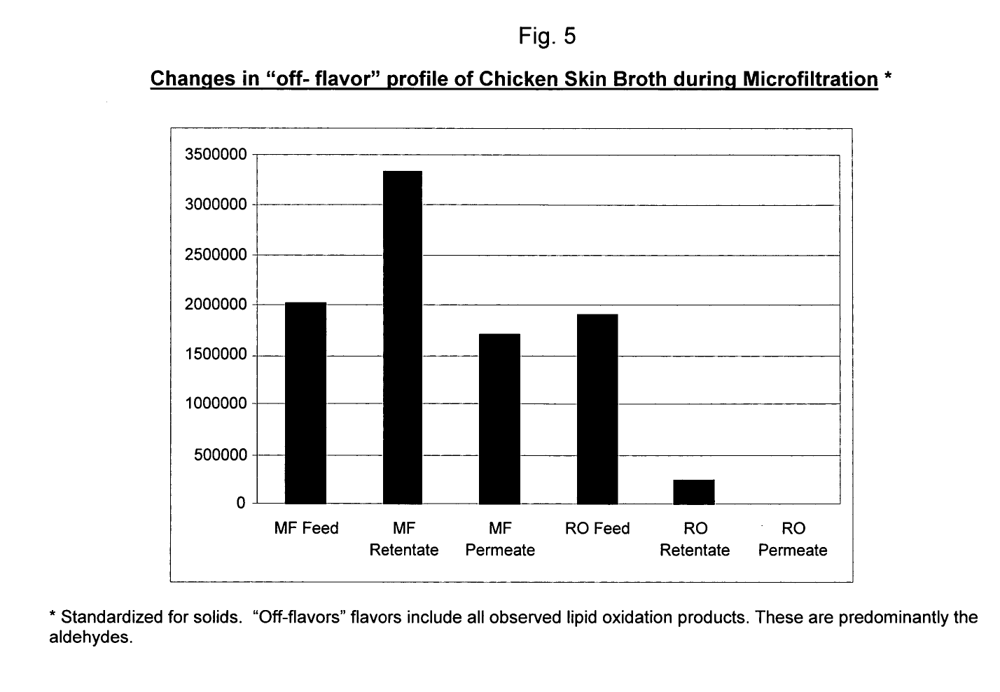

### DETAILED DESCRIPTION

The present invention relates to a membrane filtration process for removing fat, reducing water, retaining non-fat solids, and improving the flavor of meat broths made from animal products. The process is a non-thermally abusive, solvent-free concentration technique, which avoids the limitations and pitfalls of excessive heat and chemical treatments. The process includes at least one microfiltration step and at least one reverse osmosis step. Preferably, the process includes at least one protein hydrolysis step prior to the microfiltration step.

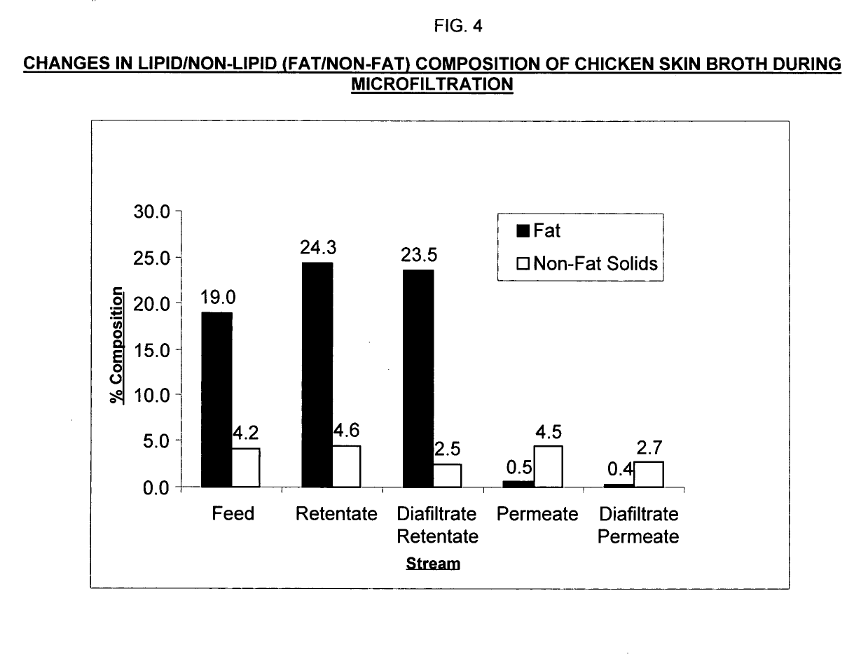

The membrane filtration process is used to remove fat through the use of microfiltration membranes. The microfiltration step effectively removes fat in order to produce a chicken broth having less than 1% fat, FIG. 4. The fat separation process is initiated by adding a small quantity of water to the chicken by-products in order to increase flux rates and reduce the overall processing time. The addition of water also helps stabilize foaming, that occurs as a result of air incorporation into the feed tank.

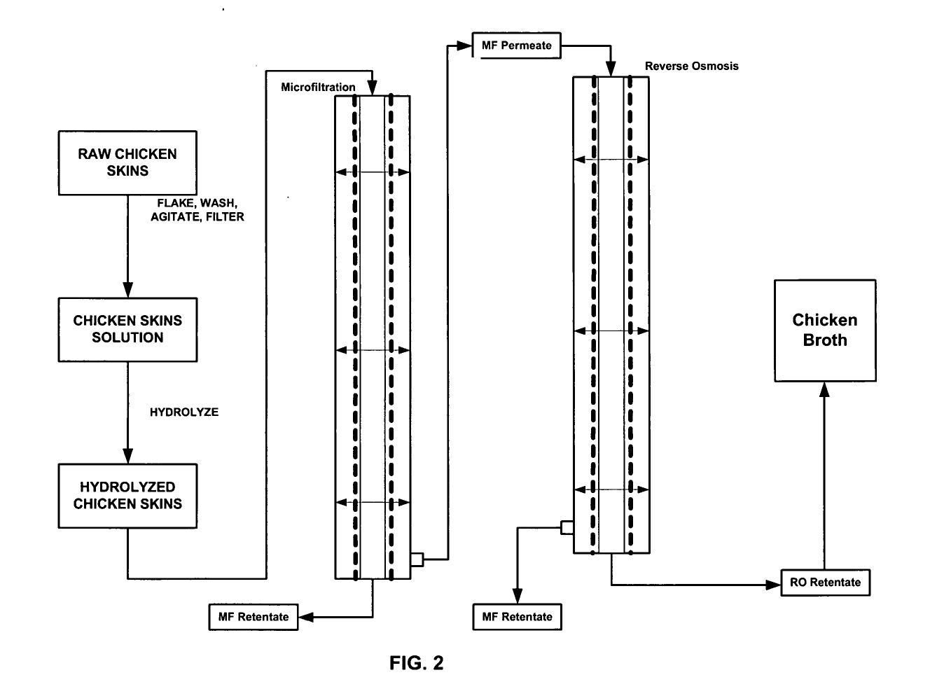

The microfiltration (MF) step is highly efficient in removing all bulky extraneous matter from the feedstock including protein polymers and fat. However, since retention of proteinaceous matter is an important process in developing a broth high in non-fat solids and rich in flavor and flavor precursor compounds, it is preferable for the proteins in chicken by-products to be initially hydrolyzed with a proteolytic enzyme such as papain to reduce the non-MF permeable, bulky protein polymers into MF permeable monomeric and oligomeric fragments, as shown in FIG. 2. The hydrolyzed fragments, primarily amino acids and dipeptides, are invaluable flavor precursors for savory flavor development. Due to the relatively small size and hydrophilic character, these hydrolyzed protein fragments readily pass through the MF membrane and are retained in the final broth, as non-fat solids, FIG. 4.

Enzymatic hydrolysis enhances the permeation and recovery of non-fat solids. Without enzyme hydrolysis, these non-fat solids would be lost in the MF concentrate along with fat globules and rendered unavailable. Papain (Florexco, Inc., Chevy Chase, Md.) is the favored proteolytic enzyme in this process due to its high yield and low cost. Other proteases including Corolase N (Rohm Enzyme, Columbus, Ohio), Protamax and Flavourzyme (Novozymes, Bagsvaerd, Denmark) can be used as substitutes but are more expensive. Other processes for breakdown of protein molecules, such as acid hydrolysis, may also be used to achieve the same effect described here.

In membrane filtration, permeation across a membrane is largely a function of the size and chemical nature of molecules. In general, membrane filtration processes extend the conventional particle filtration process from the macro-particulate size range to micro- and nano-molecular sizes. Membrane filtration processes begin at the microfiltration scale with pore sizes designed to retain molecules that permeate conventional particle filtration and having a molecular weight cutoff of approximately 20,000 daltons. Microfiltration separates components by particle size at low pressures of up to about 100 psi. Following microfiltration is the ultrafiltration process that retains molecules that permeate through microfiltration membranes down to a molecular weight cutoff of approximately 1000 daltons. Ultrafiltration separates components by molecular weight at low pressures of up to about 160 psi. Ultrafiltration is in turn followed by nanofiltration that is designed to retain molecules that permeate ultrafiltration membranes down to a molecular weight cutoff of approximately 50 daltons. Nanofiltration separates components by molecular interaction and molecular weight at moderate pressures of up to about 600 psi. The final membrane class is reverse osmosis which uses membranes having the smallest pore sizes. Reverse osmosis admits only the smallest of molecules, such as water molecules. Reverse osmosis separates components by molecular interaction and molecular weight at high pressures of up to about 1000 psi. In most food systems this is primarily water. Each filtration process yields two fractions, a retentate (also referred to as a concentrate) and a permeate. The retentate includes all the materials from the original feedstock that were exposed to the membrane but did not permeate the membrane itself. The permeate is the portion of the feedstock that passes through the membrane.

The steps of the process used in this invention are shown in FIG. 2. The first filtration step is microfiltration (MF).

Along with fat removal, fatty odors that are considered off-odors in processed chicken skins are also significantly reduced. These off-odor compounds, which include a number of aldehydes derived from the lipid oxidation process, appear to be retained in the MF retentate due to their high affinity to the lipids. The concentration of the off-odor compounds increases significantly in the MF concentrate and concurrently decreases in the MF permeate.

In membrane filtration, the technique of diafiltration can be used to further enhance the permeation of solutes across a semi-permeable membrane. Essentially, this involves a dilution of the MF retentate and recycling it through the same membrane surface in the hope of promoting further transmission of desirable, permeable constituents through the membrane. For the MF membrane, the potential exists for further passage of the desirable non-fat solids into the MF permeate stream. Diafiltration runs generate yield improvements through extended retrieval of the remaining non-fat solids in the MF retentate that are not filtered in the initial pass-through, FIG. 4. The diafiltration process can be continued until most of the non-fat solids are removed from the feed. However, the recovery of non-fat solids from repeated diafiltration runs beyond the first or second dilutions is low and is generally unproductive. The end result of the microfiltration process is a MF permeate with a less than 1% fat content and a total solids composition of 5% to 8%.

For the development of a concentrated chicken broth, microfiltration is followed by a reverse osmosis filtration step using the MF permeate as the feedstock. The intent of this filtration process is to concentrate the available solids and flavor to yield a broth with a minimum of 32% total solids while retaining the desirable characteristic aromas associated with a chicken broth. Since the commercial value of the meat broths is based on total solids content, the reverse osmosis (RO) filtration step is processed to maximize the final yield of solids without a significant loss in the flux rates. The result of the RO filtration process is a broth (retentate) that is low in fat, low in fatty off-flavors, and contains at least 32% chicken solids. The RO permeate is composed mostly of water.

The process for development of a low fat chicken broth begins with a pre-treatment of the raw chicken skins to facilitate the separation of the lipids from the remaining non-fat solids in particular proteinaceous matter and to maximize on its yield. Protein molecules are made up of amino acids held together by peptide linkages. The breakdown of these linkages generates smaller peptide fractions of amino acid units as well as individual amino acid monomers. Common proteolytic techniques include acid, thermal and enzyme hydrolysis reactions. The favored approach is the use of proteolytic enzymes for the breakdown of protein molecules. Flaked raw chicken skins containing up to 55% fatty material are gently heated with an equivalent amount (w/w) of added water and vigorously agitated in a rendering-type operation to loosen and release the fat globules, FIG. 2. The liquid fraction is than decanted and discarded and the remaining solids are washed with water. Following another decanting operation to discard the liquid portion, water is again added to the retained solids and a protease such as papain is added to break down the protein fraction of the skins into small molecules and render it more amenable for permeation through the MF membrane. The mixture is gently agitated and held at 110° F. (43° C.) for one hour. Next, the temperature is raised to approximately 180° F. (82° C.) to inactivate the previously added enzyme. The resulting matrix is a liquid consisting of homogenous, finely sized particulates with approximately 5% non-fat solids composition and a fat composition of 18% to 20%, FIG. 4. This material, referred to as hydrolyzed chicken skins, serves as the feedstock for the MF process, FIG. 2.

The membrane filtration process removes large amounts of fat without degrading the properties of the resultant chicken broth. The process results in an improvement in the overall flavor of the broth through the removal of off-flavor constituents and the retention of significant amounts of the proteinaceous solids. While some heat is involved in the preliminary stages prior to membrane filtration, the fat removal, off-flavor removal, and increase in non-fat solids are all done at temperatures below 110° F. (43° C.), thereby enhancing the stability and retention of the valuable flavors and flavor precursors.

The present invention filters the partially processed chicken skins through at least one MF membrane in order to develop a low-fat, low off-flavored broth with high flavor potential. The resulting MF permeate, containing less than 1% fat and about 5% to 8% solids is then filtered through at least one RO membrane in order to remove water and yield a broth having a high solids content. Thus, the broth obtained from the present invention is low-fat, has low off-flavors, contains at least 32% solids, is rich in flavor generating precursors, has an aroma profile reminiscent of a chicken broth and can be used as a base to form a range of chicken and other poultry flavorings. Further, the properties of the broth have not been distorted by exposure to high heat or chemical treatments during the filtration process.

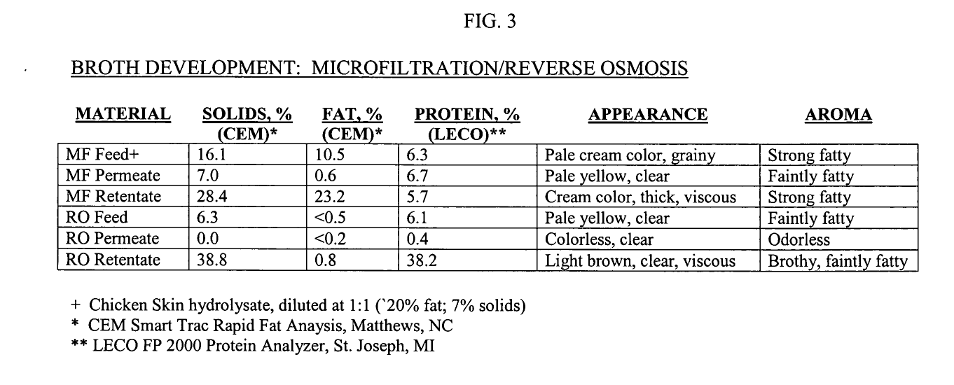

MF membranes permit the passage of micromolecules while preventing materials of greater molecular size from penetrating. When hydrolyzed chicken skins are subject to microfiltration, virtually all of the fat globules are retained in the MF retentate. Along with the fat, much of the bulky, extraneous, insoluble particulates are also retained. The resulting MF permeate is a non-fat, dilute broth containing much of the soluble, hydrolyzed chicken skin solids, and water. The solids content of this dilute chicken broth (MF permeate) is 5% to 8%. This dilute broth (MF permeate) also has a lower level of fatty off-odors and has a broth-like character with slight fatty nuances, FIG. 3.

Reverse osmosis uses the tightest available membranes, which in this application, only allows water to pass through. When the dilute broth (MF permeate) is subject to reverse osmosis, a concentrated broth (RO retentate) with solids as high as 46% is obtained. The RO permeate is almost exclusively water. No perceived odors or significant quantities of proteinaceous matter could be detected in the RO permeate, FIG. 3. The concentrated broth base (RO retentate) containing almost exclusively proteinaceous matter and water can be further processed for the development of a number of chicken and other poultry flavorings, FIG. 3.

The process described herein uses a combination of protein hydrolysis, microfiltration, and reverse osmosis to achieve the intended objective of developing a low-fat, concentrated chicken broth from chicken by-products such as chicken skins. Other membranes in the ultrafiltration (UF) and nanofiltration (NF) categories as well as pore size variations within microfiltration and reverse osmosis categories were also investigated. Incorporation of a nanofiltration process between the microfiltration and reverse osmosis runs offers the benefit of higher flux rates for the RO runs and generates a permeate that is considered to be more neutral in its overall flavor profile. Much of the valuable solids are retained in the NF concentrate which necessitates further processing steps to be incorporated in which the NF retentate can be run independently through an RO membrane as a feed stock to recover these solids. And since some solids are also present in the NF permeate, the NF permeate also must be processed through the RO system which means that two separate RO filtrations are needed. Though some differences are observed between the two RO retentates when the approach of dual NF filtration is utilized, the differences are relatively minor and not commercially significant.

It is also possible to replace the MF step with an UF step, so that the process includes an ultrafiltration step and a reverse osmosis step. However, the combination of MF and RO is considered the best approach from a commercial angle for using membrane filtration to develop a low-fat, concentrated meat broth from animal products.

### EXAMPLES

### Example 1

Example 1 was performed to determine the feasibility of using a filtration process to remove fat from chicken skins to form a low-fat chicken broth having at least 32% solids and with low off-flavors for use as a base to form a variety of chicken and other poultry flavorings. Removal of the fat was performed using a MF step, which was followed by a RO step for concentration of the remaining solids. The MF membrane was a polyvinylidene fluoride (PVDF) polymer with a pore size of 0.3 microns. A ceramic membrane of equivalent permeation rating was also used successfully. The ceramic membrane generated higher flux rates than its polymeric analog. Stainless steel membranes in this category are also expected to perform likewise. For the RO process, the membrane used was a TFM® polymer membrane (GEA Filtration, Hudson, Wis.), with a molecular weight cut off of approximately 50 daltons.

A hydrolyzed chicken skins solution was passed through the MF membrane. The MF process was run at ambient temperature with inlet pressure ranging between about 25 and about 35 psi. The MF retentate contained fat along with proteins and other extraneous materials. The MF permeate contained less than 1% fat and 5% to 8% total solids. The MF permeate was collected and fed to the RO membrane. Reverse osmosis was performed at ambient temperature and pressure of between about 450 and about 800 psi. The RO retentate collected was a low-fat chicken broth containing over 32% solids. The RO permeate was water. The chicken broth developed here was used as a base to prepare a variety of chicken and other poultry flavorings and was also used as a replacement ingredient for a commercial chicken broth. This broth has negligible amounts of fat, is high in soluble proteins, low in off-flavor and has a mild broth-like flavor, FIG. 3. Poultry flavors formulated from broth generated through this process were deemed to be equivalent or better than those developed with a commercially purchased broth. Thus, a low-fat chicken broth containing at least 32% solids and good flavor generation potential was produced using the filtration method without the use of high heat or chemical treatments.

### Example 2

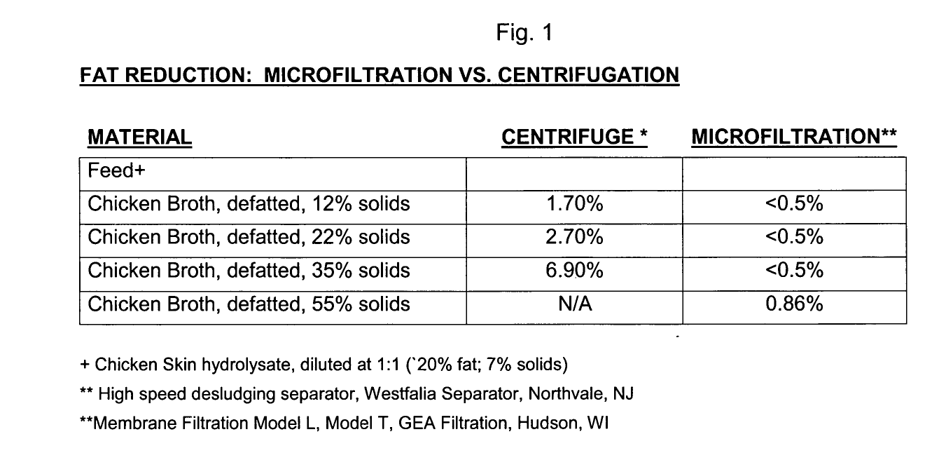

Example 2 compares fat reduction using the microfiltration process of the current invention verses centrifugation. The starting material for each of the four comparisons is hydrolyzed chicken skins solution containing 18% to 20% fat. The high speed desludging separator, Model SA1 (Westfalia Separator, Inc., Northvale, N.J.) was used to centrifuge the hydrolyzed chicken skins solution during the centrifugation test. The MF membrane used was identical to the MF membrane used in Example 1. As noted in Example 1, after the MF step, the MF permeate was fed through a RO membrane which yielded the chicken broth having total solids as high as 46%. The fat reduction efficiency of both techniques was compared at solids levels of 12%, 22%, 35% and 55%, FIG. 1. For centrifugation, all concentration steps were performed using a standard evaporation technique starting with a 12% solids broth that resulted from the defatted centrifuge run. As previously stated, heating the broth at or near boiling temperatures for the evaporation process is generally detrimental for the preservation of flavor precursors in the broth. In the case of membrane filtration, all concentration steps were performed at temperatures below 110° F. (43° C.) leading to a final yield of a 46% solids broth. This material was subsequently evaporated to 55% for the comparison test.

As seen in FIG. 1, chicken broth developed using centrifugation showed higher fat content at all solids level tested. Even in a highly concentrated form, the fat level of the membrane filtered chicken broth did not exceed 1% of the total broth composition. For the centrifugation process, we were unable to reduce the fat composition below 1% in these trials. For the concentration of solids, reverse osmosis appears to be a superior technique to centrifugation. A great deal of time and effort is needed to improve on the 12% solids yield obtained with centrifugation. And at best, such an improvement is expected to be marginal. With membrane filtration, yields as high as 46% were obtained. Though further concentration efforts beyond 46% solids were slowed by the low flux rates and were not attempted in these trials, it is possible to extend this concentration level at the expense of time. Still, a broth with solids composition at or close to 46% and little or no distortion of its flavor precursor composition has a high market value and is a highly desirable product for the development of chicken and other poultry flavorings.

This example shows that the membrane filtration process using a combination of microfiltration and reverse osmosis does a better job of removing fat from the chicken skins broth while retaining more of the non-fat solids compared to centrifugation. Based on these results, it is believed that the membrane filtration treatment of hydrolyzed chicken skins being a non-thermal, chemical-free process exclusively generates a low-fat chicken broth with a high solids content.

### Example 3

Example 3 was conducted to demonstrate the effect of the proteolytic process for enhancing the retention of non-fat solids and in particular proteinaceous matter. While various enzymes were investigated for determining the optimum degree of hydrolysis, papain was selected based on its high proteolytic activity and low cost. Flaked chicken skins were partially defatted to remove much of the loosely held fat globules. An equivalent amount of water was added. To this water/chicken skins mixture, 0.25% of papain was added and the product agitated for one hour at 120° F. Following inactivation of the enzymes at 180° F., the hydrolyzed skins which now appear as a fine, homogenous suspension were filtered through a microfiltration process followed by a reverse osmosis process. The broth derived from the RO retentate was used as a base ingredient in a chicken flavor formulation in place of a commercial chicken broth. The resulting chicken flavor developed from this chicken skins broth was compared to a chicken flavor developed from the commercial broth by an in-house sensory panel. The two chicken flavors were deemed to be equivalent in all regards.

Thus, a chicken broth with high protein content was developed (FIG. 2) through the enzymatic hydrolysis of these bulky molecules without the use of acid or thermal treatments. The end product is a protein rich, low fat broth with good flavor and flavor generation potential for the development of a variety of chicken and other poultry flavorings.

Thus, there has been shown and described a membrane filtration process for removing fat from animal products and a broth made from the product of the filtration process, which fulfill all the objectives and advantages sought therefore. It is apparent to those skilled in the art, however, that many changes, variations, modifications, and other uses and applications for the membrane filtration process and broth product are possible, and also such changes, variations, modifications, and other uses and applications which do not depart from the spirit and scope of the invention are deemed to be covered by the invention, which is limited only by the claims which follow.

1. A membrane filtration process for development of a low-fat, concentrated meat broth comprising the steps of:
(a) filtering a feed solution containing animal products through a microfiltration membrane, and collecting a microfiltration permeate; and,
(b) filtering the microfiltration permeate through a reverse osmosis membrane, wherein a reverse osmosis retentate is the low-fat, concentrated meat broth.

2. The membrane filtration process of claim 1 comprising hydrolizing the animal products to form the feed solution.

3. The membrane filtration process of claim 1, wherein the animal product is a chicken product.

4. The membrane filtration process of claim 3, wherein the chicken product is chicken skins.

5. The membrane filtration process of claim 1, wherein the microfiltration permeate is comprised of less than 1% fat and between about 1% and about 10% solids.

6. The membrane filtration process of claim 1, wherein the reverse osmosis retentate contains less than 1% fat and between about 32% and about 46% solids.

7. The membrane filtration process of claim 6, wherein the reverse osmosis retentate contains at least 32% solids.

8. The membrane filtration process of claim 1, further comprising the steps: of:
(a) filtering the microfiltration permeate through a nanofiltration membrane and collecting a nanofiltration permeate and a nanofiltration retentate
(b) filtering the nanofiltration permeate through the reverse osmosis membrane and collecting the resulting reverse osmosis retentate;
(c) filtering the nanofiltration retentate through the reverse osmosis membrane and collecting the resulting reverse osmosis retentate; and
(d) mixing the two resulting reverse osmosis retentates, thereby forming the low-fat concentrated meat broth.

9. The membrane filtration process of claim 1, further comprising the steps of:
(a) diluting the microfiltration retentate;
(b) filtering the microfiltration retentate through the microfiltration membrane;
(c) collecting the resulting microfiltration permeate; and
(d) filtering the resulting microfiltration permeate through a reverse osmosis membrane, thereby forming the low-fat concentrated meat broth.

10. A low-fat concentrated meat broth product formed by the membrane filtration process of claim 1.

11. A non-thermal, non-enzymatic process for removing fat from hydrolyzed chicken products and by-products including the steps of:
(a) hydrolyzing animal products and by-products;
(b) filtering a feed solution containing the hydrolyzed animal products or by-products through a microfiltration membrane, collecting a microfiltration permeate; and,
(c) filtering the microfiltration permeate through a reverse osmosis membrane, wherein a reverse osmosis retentate is a low-fat broth having less than 1% fat and having at least 32% solids.

12. A meat broth product formed by the non-thermal, non-enzymatic process of claim 11.

13. A membrane filtration process for removing fat from chicken by-products including the steps of:
(a) hydrolizing a feed solution containing chicken by-products with a proteolytic enzyme;
(b) filtering the feed solution through a microfiltration membrane, collecting a microfiltration permeate;
(c) filtering the microfiltration permeate through a reverse osmosis membrane, wherein a reverse osmosis retentate is a low-fat broth containing less than 1% fat and having at least 32% solids.

14. The membrane filtration process of claim 13, wherein the proteolytic enzyme is selected from the group consisting of papain, corolase N, Protamax and flavourzyme.

15. A chicken broth product formed from chicken skins, containing less than 1% fat, at least 32% solids, and flavor precursor compounds, while not containing chemicals.
